(19) United States
(12) Patent Application Publication
(10) Pub. No.: US 2008/0205635 A1
(43) Pub. Date: Aug. 28, 2008

(54) APPARATUS, SYSTEM, AND METHOD FOR SELF-DESCRIBING HETEROGENEOUS MAGNETIC TAPE FORMATTING

(76) Inventors: Glen Alan Jaquette, Tucson, AZ (US); Scott Jeffrey Schaffer, Tucson, AZ (US); Toshiyuki Shiratori, Tokyo (JP)

Correspondence Address: Brian C. Kunzler;Kunzler and Associates, Suite 600, 8 East Broadway, Salt Lake City, UT, 84111, US

(21) Appl. No.: 11/679,736

(22) Filed: Feb. 27, 2007

(51) Int. Cl. H04L 9/28; H04K 1/00

(52) U.S. Cl. 380/28; 380/22

(57) ABSTRACT

An apparatus, system, and method are disclosed for self-describing, heterogeneous magnetic tape formatting. A detection module determines if data is to be encrypted when written to a magnetic tape in response to a host command and if the data is already encrypted. An encryption module encrypts the data if the data is to be encrypted and if the data is not already encrypted. A write module writes a reserved codeword followed by the data to the magnetic tape wherein the reserved codeword is configured as an encryption reserved codeword if the data is encrypted. If the data is not encrypted, the reserved codeword is configured as a clear reserved codeword. The encrypted and unencrypted data segments are intermixed on the magnetic tape.

### BACKGROUND OF THE INVENTION

1. Field of the Invention

This invention relates to magnetic tape formatting and more particularly relates to self-describing heterogeneous magnetic tape formatting.

2. Description of the Related Art

Magnetic tapes are frequently used to store large quantities of data at a low per unit cost. A tape drive may write data to a magnetic tape and later read the data from the magnetic tape. For example, a data processing system may back up the data from one or more hard disk drives to one or more magnetic tapes. The magnetic tapes may be stored, allowing the data to be recovered in the future if there is ever a need for the data.

The data stored on magnetic tape is often sensitive. As a result, a tape drive may encrypt data that is written to the magnetic tape. In addition, the tape drive may decrypt the encrypted data as the encrypted data is read from the magnetic tape.

The tape drive may encrypt the data by employing an algorithm to modify the data. As modified, the values of the data are obscured. The tape drive may employ an encryption key. The encryption key may be random number of a specified length. The encryption key is used by the encryption algorithm (such as the Advanced Encryption Standard (AES)) to encrypt the data.

Similarly, the tape drive may employ a reverse algorithm to decrypt the data. The reverse algorithm may also use the same encryption key (symmetric encryption) or a counterpart key (asymmetric encryption), the decryption key. For example, only a tape drive that possesses the encryption key (symmetric encryption) or decryption key (asymmetric encryption) may be able to decrypt the encrypted data. After the data is decrypted, the data values may be recognized and used.

Unfortunately, encrypting data imposes an added encryption/decryption cost to reading and writing data to the magnetic tape. For example, encryption keys must be created, stored, and retrieved. In addition, the tape drive must perform encryption and decryption operations as part of the write and read operations respectively.

### SUMMARY OF THE INVENTION

From the foregoing discussion, there exists a need for an apparatus, system, and method that format magnetic tape with a self-describing, heterogeneous format. Beneficially, such an apparatus, system, and method would allow encrypted and unencrypted data segments to be stored intermixed on a magnetic tape.

The present invention has been developed in response to the present state of the art, and in particular, in response to the problems and needs in the art that have not yet been fully solved by currently available magnetic tape formatting methods. Accordingly, the present invention has been developed to provide an apparatus, system, and method for creating a self-describing, heterogeneous format that overcome many or all of the above-discussed shortcomings in the art.

The apparatus for creating a self-describing, heterogeneous format is provided with a plurality of modules configured to functionally execute the steps of determining if data is to be encrypted, encrypting the data, and writing a reserved codeword followed by the data. These modules in the described embodiments include a detection module, an encryption module, and a write module. The apparatus may also include a read module, an identification module, a compression module, a decompression module, and a decryption module.

The detection module determines if data is to be encrypted when written to a magnetic tape in response to a host command and if the data is already encrypted. The encryption module encrypts the data if the data is to be encrypted and if the data is not already encrypted.

The write module writes a reserved codeword followed by the data to the magnetic tape wherein the reserved codeword is configured as an encryption reserved codeword if the data which follows the reserved codeword is encrypted. If the data which follows the reserved codeword is not encrypted, the reserved codeword is configured as a clear reserved codeword. A reserved codeword and the data that follows it, before the next reserved codeword is encountered, can be referred to as a segment of data. The encrypted and unencrypted data segments are intermixed on the magnetic tape.

In one embodiment, the compression module compresses the data. The read module may read the magnetic tape as a plurality of words. The identification module may identify the reserved codeword from the plurality of words. If the identification module detects an encryption reserved codeword, the decryption module may decode any encoding that would have been performed on the write side. The apparatus writes encrypted and unencrypted data segments intermixed on the magnetic tape.

A system of the present invention is also presented for creating a self-describing, heterogeneous format. The system may be embodied in a tape drive. In particular, the system, in one embodiment, includes a magnetic tape, a head, and a controller.

The magnetic tape stores magnetically encoded data. The head writes data to and reads data from the magnetic tape. The controller writes data to and reads data from the magnetic tape through the head.

The controller includes a detection module, an encryption module, a write module, a read module, and an identification module. The detection module determines if data is to be encrypted when written to the magnetic tape in response to a host command and if the data is already encrypted. The encryption module encrypts the data if the data is to be encrypted and if the data is not already encrypted.

The write module writes a reserved codeword followed by the data to the magnetic tape wherein the reserved codeword is configured as an encryption reserved codeword if the data is encrypted. If the data is not encrypted, the reserved codeword is configured as a clear reserved codeword. The encrypted and unencrypted data segments are intermixed on the magnetic tape.

The read module reads the magnetic tape as a plurality of words. The identification module identifies the reserved codeword from plurality of words and replaces the reserved codeword with zeros if the reserved codeword is the clear reserved codeword. The read module further transfers the data from the magnetic tape. The system writes encrypted and unencrypted data segments to the magnetic tape.

A method of the present invention is also presented for creating a self-describing heterogeneous format. The method in the disclosed embodiments substantially includes the steps to carry out the functions presented above with respect to the operation of the described apparatus and system. In one embodiment, the method includes determining if data is to be encrypted, encrypting the data, and writing a reserved codeword followed by the data.

A detection module determines if data is to be encrypted when written to a magnetic tape in response to a host command and if the data is already encrypted. An encryption module encrypts the data if the data is to be encrypted and if the data is not already encrypted. A write module writes a reserved codeword followed by the data to the magnetic tape wherein the reserved codeword is configured as an encryption reserved codeword if the data is encrypted. If the data is not encrypted, the reserved codeword is configured as a clear reserved codeword. The encrypted and unencrypted data segments are intermixed on the magnetic tape.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention creates a self-describing, heterogeneous format for encrypted and unencrypted data on a magnetic tape. The present invention allows the encrypted and unencrypted data segments to be intermixed on the magnetic tape. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a tape drive system in accordance with the present invention;

FIG. 2 is a schematic block diagram illustrating one embodiment of a self-describing, heterogeneous format apparatus of the present invention;

FIG. 3 is a schematic block diagram illustrating one embodiment of a magnetic tape of the present invention;

FIG. 4A is a text diagram illustrating one embodiment of a clear data reserved codeword of the present invention;

FIG. 4B is a text diagram illustrating one embodiment of an encryption reserved codeword of the present invention;

FIG. 4C is a text diagram illustrating one embodiment of a zero codeword of the present invention;

FIG. 5 is a schematic flow chart diagram illustrating one embodiment of a write method of the present invention;

FIG. 6 is a schematic flow chart diagram illustrating one embodiment of an unencrypted write method of the present invention;

FIG. 7 is a schematic flow chart diagram illustrating one embodiment of a read method of the present invention; and

FIG. 8 is a schematic flow chart diagram illustrating one embodiment of a raw data read method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

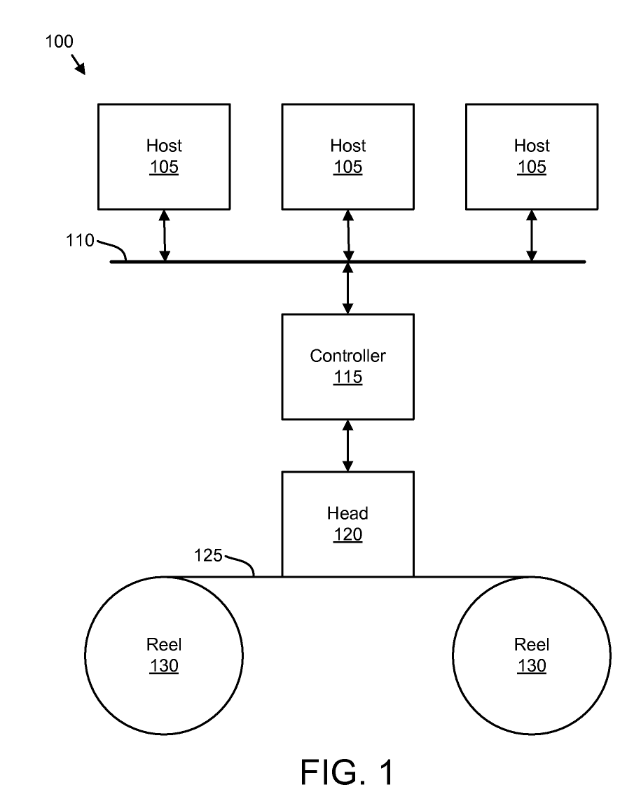

FIG. 1 is a schematic block diagram illustrating one embodiment of a tape drive system 100 in accordance with the present invention. The system 100 includes one or more hosts 105, a network 110, a controller 115, a head 120, a magnetic tape 125, and one or more reels 130.

The hosts 105 may be computer workstations, servers, mainframe computers, laptop computers, and the like. The network 110 may be a local area network (LAN), a storage area network (SAN), a wide area network (WAN), a local data bus, an intranet, the Internet, and the like.

The reels 130 spool the magnetic tape 125. One reel 130 may be disposed within a cartridge. When the cartridge is placed within the tape drive system 100, the magnetic tape 125 may be spooled to the other reel 130. The reels 130 may transport the magnetic tape 125 past the head 120.

The hosts 105 may communicate data over the network 110 to the controller 115 for storage on the magnetic tape 125. The controller 115 may encode the data as a write signal and communicate the write signal to the head 120. The head 120 writes the write signal to the magnetic tape as encoded magnetic polarities as is well known to those of skill in the art. For example, a first magnetic polarity may encode a binary one (1) and a second magnetic polarity may encode a binary zero (0).

The data may be compressed when written to the magnetic tape 125. In one embodiment, the data is encrypted with the Streaming Lossless Data Compression (SLDC) format as defined by the European Computer Manufacturer's Association.

The head 120 may also read encoded data from the magnetic tape 125, generating a read signal. The controller 115 may convert the read signal into the data that is usable by the hosts 105.

A host 105 may direct that the controller 115 write data to the magnetic tape 125 in an encrypted format. In addition, the host 105 may direct the controller 115 to write data to the magnetic tape 125 in an unencrypted format. As will be described hereafter, the present invention creates self-describing, heterogeneous formats on the magnetic tape 125 that allow the encrypted and unencrypted data segments to be intermixed.

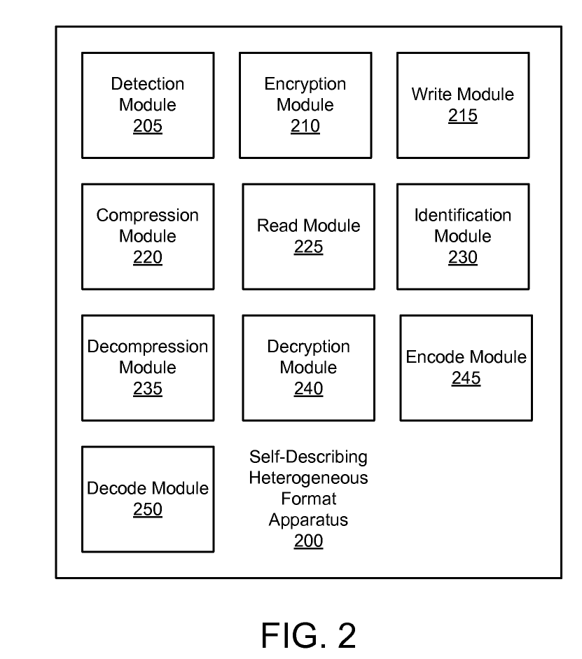

FIG. 2 is a schematic block diagram illustrating one embodiment of a self-describing, heterogeneous format apparatus 200 of the present invention. The apparatus 200 includes a detection module 205, an encryption module 210, and a write module 215. In addition, the apparatus 200 may include a compression module 220, a read module 225, an identification module 230, a decompression module, 235, a decryption module 240, an encode module 245, and a decode module 250. The description of the apparatus 200 may refer to elements of FIG. 1, like numbers referring to like elements.

In one embodiment, the detection module 205, encryption module 210, write module 215, compression module 220, read module 225, identification module 230, decompression module, 235, decryption module 240, encode module 245, and decode module 250 may be each realized as a set of semiconductor circuits in a single application specific integrated circuit (ASIC) embodied by the controller 115. Alternatively, each module may be realized as a discrete ASIC. In an alternate embodiment, the detection module 205, encryption module 210, write module 215, compression module 220, read module 225, identification module 230, decompression module, 235, decryption module 240, encode module 245, and decode module 250 are each embodied in one or more software processes executed by the controller 115 as is well known to those of skill in the art.

The detection module 205 determines if data is to be encrypted when written to a magnetic tape 125 in response to a host command and if the data is already encrypted. The encryption module 210 encrypts the data if the data is to be encrypted and if the data is not already encrypted. In some formats there may be additional encoding after encryption, to structure the data stream so that codewords can be embedded into it. Encrypted data which is not encoded is essentially random and will randomly produce bit streams which will equal embedded codewords which have special significance, whether they are reserved or not. In the SLDC case it is Scheme 2 encoding, which structures the data stream such that codewords which have special significance can be inserted (on write) and faithfully detected (on read). And codeword here is being used to refer to compression codewords, which are sequenced such that sets of bits are recognizable as words of the compression code, or codewords.

The write module 215 writes a reserved codeword followed by the data to the magnetic tape 125. In one embodiment, the reserved codeword does not exceed four (4) bytes in length. The reserved codeword is an encryption reserved codeword if the data is encrypted. If the data is not encrypted, the reserved codeword is a clear reserved codeword. The encrypted and unencrypted data segments are intermixed on the magnetic tape.

In one embodiment, the compression module 220 compresses the data. The read module 225 may read the magnetic tape as a plurality of words. The identification module 230 may identify the reserved codeword from the plurality of words. In addition, the identification module 230 may replace the reserved codeword with zeros if the reserved codeword is the clear reserved codeword.

The decompression module 235 may decode the compressed data. The decryption module 240 may decrypt the decoded data if the specified reserved codeword is the encryption reserved codeword. The read module 225 may also transfer the data from the magnetic tape 125.

In one embodiment, the encode module 245 encodes the data with a Scheme 2 encoding as is well know to those of skill in the art. The decode module 250 may decode Scheme 2 encoded data. The apparatus 200 writes encrypted and unencrypted data segments intermixed on the magnetic tape 125.

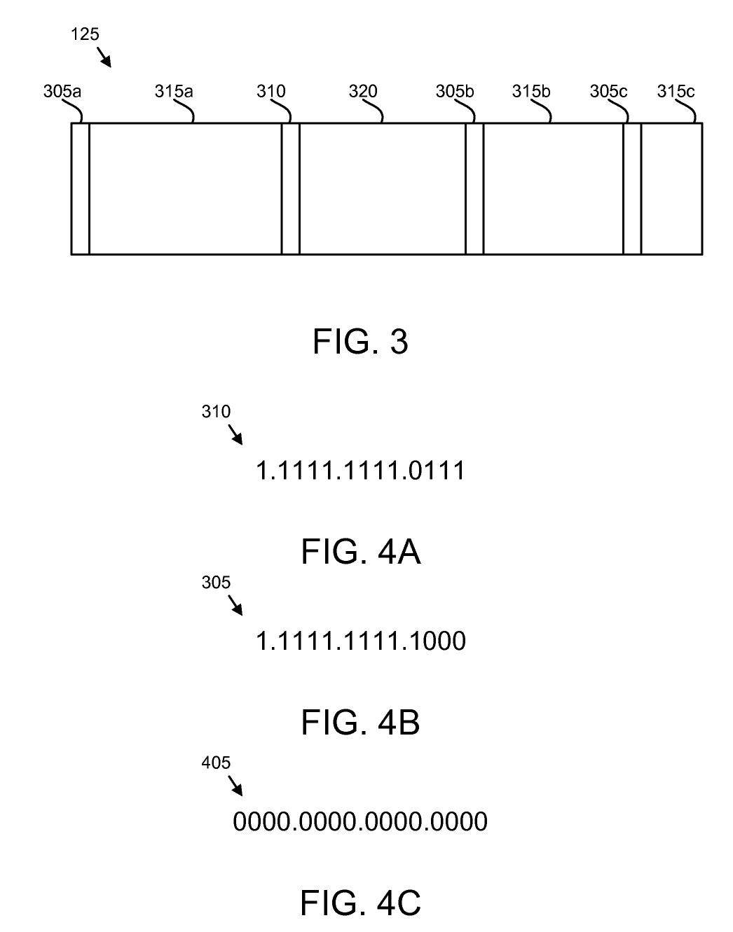

FIG. 3 is a schematic block diagram illustrating one embodiment of a magnetic tape 125 of the present invention. For simplicity, a portion of the magnetic tape 125 is shown, although the magnetic tape 125 may be of any length. In addition, the magnetic tape 125 is depicted as comprising a single track, although any number of tracks may be employed. The magnetic tape 125 is the magnetic tape 125 of FIG. 1.

One or more encryption reserved codeword 305 are written to the magnetic tape 125. Each encryption reserved codeword 305 is followed by encrypted data 315 as will be described hereafter. A clear data reserved codeword 310 is also shown written on the magnetic tape 125. The clear reserved codeword 310 is followed by unencrypted data 320 as will be described hereafter.

FIG. 4A is a text diagram illustrating one embodiment of a clear data reserved codeword 310 of the present invention. The clear data reserved codeword 310 is shown as a thirteen-bit binary value ‘1.1111.1111.0111.’ The clear data reserved codeword 310 may be compatible with SLDC reserved values. In an alternate embodiment, the clear data reserved codeword 310 may be at least one of the thirteen bit binary values presently reserved by SLDC including ‘1.1111.1111.0111,’ ‘1.1111.1111.1000,’ ‘1.1111.1111.1001,’ ‘1.1111.1111.1010,’ ‘1.1111.1111.1011,’ ‘1.1111.1111.1100,’ ‘1.1111.1111.1101,’ and/or ‘1.1111.1111.1110.’ In one embodiment, the clear data reserved codeword 310 is padded with nineteen trailing binary zeros (0) to form a thirty-two (32) bit binary value.

FIG. 4B is a text diagram illustrating one embodiment of an encryption reserved codeword 305 of the present invention. The encryption reserved codeword 305 is shown as the thirteen-bit binary value ‘1.0000.0000.1000.’ In an alternate embodiment, the encryption reserved codeword 305 may be at least one of the thirteen bit binary values reserved by SLDC including ‘1.1111.1111.0111,’ ‘1.1111.1111.1000,’ ‘1.1111.1111.1001,’ ‘1.1111.1111.1010,’ ‘1.1111.1111.1011,’ ‘1.1111.1111.1100,’ ‘1.1111.1111.1101,’ and/or ‘1.1111.1111.1110.’ The clear data reserved codeword 310 and the encryption reserved codeword 305 are never the same reserved codeword.

FIG. 4C is a text diagram illustrating one embodiment of a zero codeword 405 of the present invention. The zero codeword 405 is shown as the sixteen-bit binary value ‘0000.0000.0000.0000.’ The zero codeword 405 may replace the clear data reserved codeword 310 as will be described hereafter.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

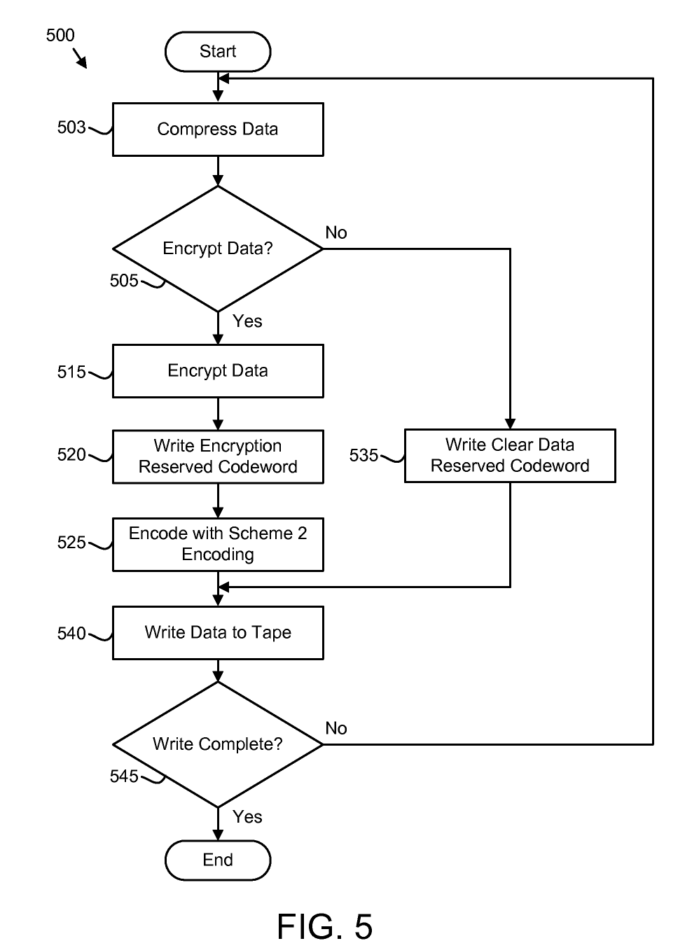

FIG. 5 is a schematic flow chart diagram illustrating one embodiment of a write method 500 of the present invention. The method 500 substantially includes the steps to carry out the functions presented above with respect to the operation of the described apparatus and system of FIGS. 1-4 for writing encrypted and unencrypted data segments to the magnetic tape 125. Specifically, the method 500 describes writing standard data in either a clear unencrypted format or in a compressed format. The description of the method 500 refers to elements of FIGS. 1-4, like numbers referring to like elements.

The method 500 begins and the compression module 220 compresses 503 the data. In one embodiment, the compression module 220 compresses 503 with SDLC. The detection module 205 determines 505 if data is to be encrypted when written to a magnetic tape 125 in response to a command from a host 105. If the detection module 505 determines 505 that the data is not to be encrypted, the write module 215 writes 535 the clear reserved codeword 310 to the magnetic tape 125. The write module 215 also writes 540 the compressed data to the magnetic tape 125.

If the detection module 505 determines 505 that the data is to be encrypted, the encryption module 210 encrypts 515 the compressed data. In one embodiment, the encryption module 210 encrypts 515 the compressed data using the Galois/Counter Mode algorithm as defined by the P1619.1 standard published by the Security in Storage Work Group of the Institute of Electrical and Electronic Engineers of New York, N.Y. Encrypting the data may add forty-eight (48) bytes to each block of data.

The write module 215 writes 520 a reserved codeword to the magnetic tape 125. In one embodiment, the encode module 245 encodes 525 the encrypted, compressed data with Scheme 2 encoding as is well known to those of skill in the art. The write module 215 further writes 540 the Scheme 2 encoded data to the magnetic tape 125.

The detection module 205 may determine 545 if writes to the magnetic tape 125 are complete. If the detection module 205 determines 545 that writes are not complete, the detection module 205 determines 505 if data for a subsequent write is to be encrypted when written to the magnetic tape 125. If the detection module 205 determines 545 that the writes are complete, the method 500 terminates. The method 500 writes self-describing, heterogeneous formatting to the magnetic tape 125, allowing encrypted data 315 and unencrypted data 320 to be intermixed on the tape 125.

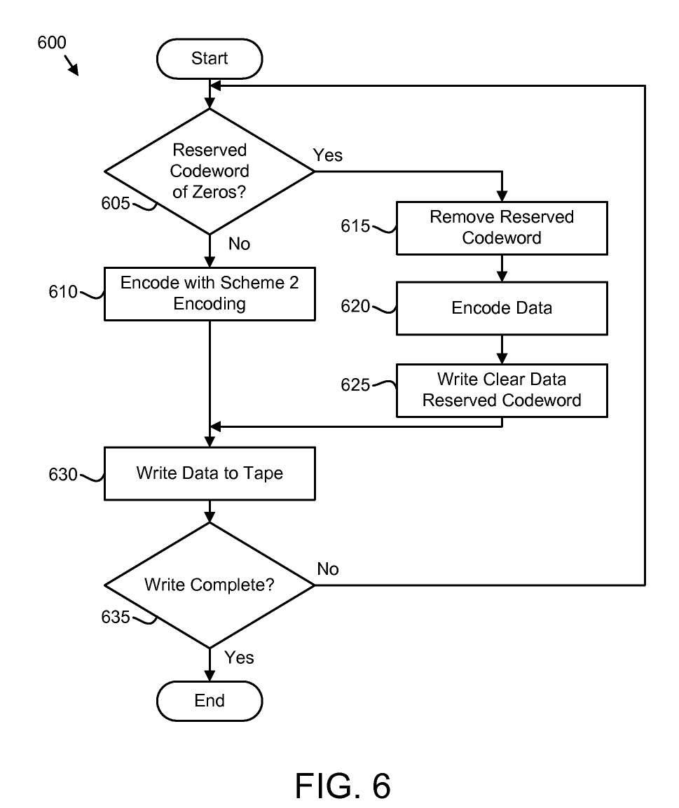

FIG. 6 is a schematic flow chart diagram illustrating one embodiment of an unencrypted write method 600 of the present invention. The method 600 substantially includes the steps to carry out the functions presented above with respect to the operation of the described apparatus and system of FIGS. 1-4. Specifically, the method 600 may read data in a SDS format and write the data in a self-describing heterogeneous format. The description of the method 600 refers to elements of FIGS. 1-5, like numbers referring to like elements.

The method 600 begins and in one embodiment, the detection module 205 determines 605 if a reserved codeword of data from a host 105 is all binary zeros such as the zero codeword 405. If the detection module 205 determines 605 that the reserved codeword is all binary zeros, the detection module 205 may remove 615 the reserved codeword from the data. In one embodiment, the compression module 220 encodes 620 the data. The compression module 220 may encode 620 the data with SDLC. The write module 215 writes 625 the clear reserved codeword 310 to the magnetic tape 125 and also writes 630 the compressed data to the magnetic tape 125.

If the detection module 205 determines 605 that the reserved codeword is not all binary zeros, the encode module 245 may encode 610 the data with Scheme 2 encoding. The write module 220 may write 630 the Scheme 2 encoded data to the magnetic tape 125. The compressed data may include the encryption reserved codeword 305. The detection module 205 may further determine 635 if writes to the magnetic tape 125 are complete.

If the detection module 205 determines 635 that writes are not complete, the detection module 205 determines 605 if the reserved codeword of data for a subsequent write is all binary zeros. If the detection module 205 determines 605 that the writes are complete, the method 600 terminates.

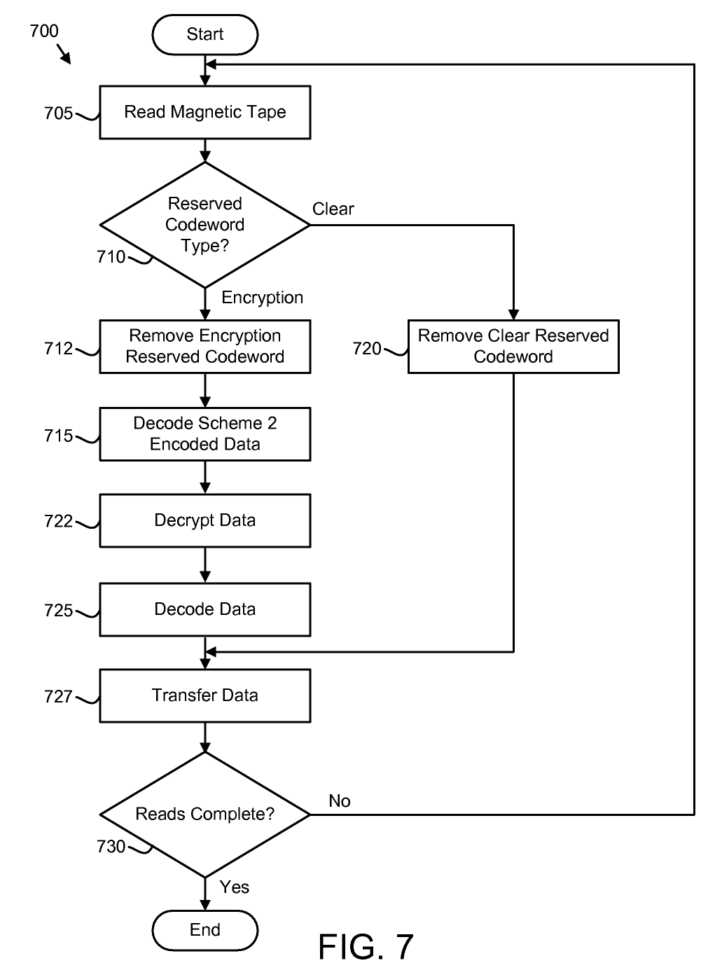

FIG. 7 is a schematic flow chart diagram illustrating one embodiment of a read method 700 of the present invention. The method 700 substantially includes the steps to carry out the functions presented above with respect to the operation of the described apparatus and system of FIGS. 1-4. Specifically, the method 700 reads self-describing heterogeneous format data and sends the data to a host 105 as cleartext. The description of the method 700 refers to elements of FIGS. 1-6, like numbers referring to like elements. In one embodiment, a host 105 may select the method 700 in order that unencrypted data 320 is not decrypted while encrypted data 315 is decrypted.

The method 700 begins and in one embodiment, the read module 225 reads 705 the magnetic tape 125 as a plurality of words. The identification module 330 may identify 710 the reserved codeword from the plurality of words.

If the identification module 330 identifies 710 the reserved codeword as the clear data reserved codeword 310, the identification module 230 may remove 720 the clear data reserved codeword 310 from the data.

If the identification module 330 identifies 710 the reserved codeword as the encryption reserved codeword 305, the identification module 710 may remove 712 the encryption reserved codeword 305 from the data. In one embodiment, the decode module 250 decodes 715 the Scheme 2 encoded data and the decryption module 240 decrypts 722 the data. The decompression module 235 may decode 725 the compressed data.

The read module 225 may transfer 727 the data from the magnetic tape 125. In addition, the read module 225 determines 730 if reads are complete. If reads are not complete, the read module 225 reads 705 the magnetic tape 125. If the read module 225 determines 730 that the reads from the magnetic tape 125 are complete, the method 700 terminates.

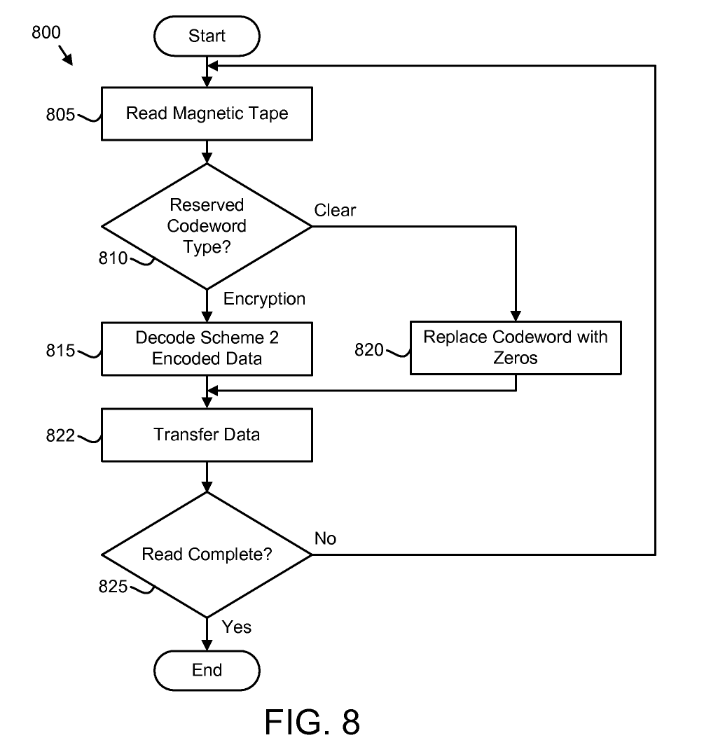

FIG. 8 is a schematic flow chart diagram illustrating one embodiment of a raw data read method 800 of the present invention. The method 800 substantially includes the steps to carry out the functions presented above with respect to the operation of the described apparatus and system of FIGS. 1-4. Specifically the method 800 may read self-describing heterogeneous format data and send the data to the host 105 in SDS format. The description of the method 800 refers to elements of FIGS. 1-7, like numbers referring to like elements. In one embodiment, a host 105 may select the method 800 in order that encrypted data 315 is not decrypted but instead is translated as raw data from a storage format to a transfer format.

The method 800 begins and in one embodiment, the read module 225 reads 805 the magnetic tape 125. The identification module 330 may identify 810 the reserved codeword from the plurality of words read 805 by the read module 225.

If the identification module 330 identifies 810 the reserved codeword as the clear data reserved codeword 310, the identification module 230 may replace 820 the clear data reserved codeword 510 with all zeros (0) such as embodied by the zero codeword 405. If the identification module 330 identifies 810 the reserved codeword as the encryption reserved codeword 305, the decode module 250 decodes 815 the Scheme 2 encoded data.

The read module 225 may transfer 822 the data from the magnetic tape 125. In addition, the read module 225 determines 825 if reads are complete. If reads are not complete, the read module 225 reads 805 the magnetic tape 125. If the read module 225 determines 825 that the reads from the magnetic tape 125 are complete, the method 800 terminates.

The embodiment of the present invention creates a self-describing, heterogeneous format for encrypted data 315 and unencrypted data 320 on the magnetic tape 125. The present invention allows the encrypted data 315 and unencrypted data 320 to be intermixed on the magnetic tape 125.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for creating a self-describing, heterogeneous format, the apparatus comprising:
a detection module comprising semiconductor circuits and configured to determine if data is to be encrypted when written to a magnetic tape in response to a host command and if the data is already encrypted;
an encryption module comprising semiconductor circuits and configured to encrypt the data if the data is to be encrypted and if the data is not already encrypted; and
a write module comprising semiconductor circuits and configured to write a reserved codeword followed by the data to the magnetic tape wherein the reserved codeword is configured as an encryption reserved codeword if the data is encrypted else the reserved codeword is configured as a clear data reserved codeword, wherein encrypted and unencrypted data segments are intermixed on the magnetic tape.

2. The apparatus of claim 1, the apparatus further comprising:
a read module comprising semiconductor circuits and configured to read the magnetic tape as a plurality of words;
an identification module comprising semiconductor circuits and configured to identify the reserved codeword from plurality of words and replace the reserved codeword with zeros if the reserved codeword is the clear data reserved codeword; and
the read module further configured to transfer the data from the magnetic tape.

3. The apparatus of claim 1, further comprising a compression module comprising semiconductor circuits and configured to compress the data.

4. The apparatus of claim 3, the apparatus further comprising:
a read module comprising semiconductor circuits and configured to read the magnetic tape as a plurality of words;
an identification module comprising semiconductor circuits and configured to identify the reserved codeword from plurality of words;
a decompression module comprising semiconductor circuits and configured to decode the compressed data;
a decryption module comprising semiconductor circuits and configured decrypt the decoded data if the specified reserved codeword is the encryption reserved codeword; and
the read module further configured to transfer the data from the magnetic tape.

5. The apparatus of claim 4, wherein the decryption module does not decrypt the decoded data if the reserved codeword is the encryption reserved codeword and the read module is reading the magnetic tape in a raw data mode in response to a host command.

6. The apparatus of claim 1, wherein the plurality of reserved codewords are Streaming Lossless Data Compression format reserved values of not more than four bytes.

7. The apparatus of claim 6, wherein the clear data reserved codeword comprises a binary value selected from 1.1111.1111.0111, 1.1111.1111.1000, 1.1111.1111.1001, 1.1111.1111.1010, 1.1111.1111.1011, 1.1111.1111.1100, 1.1111.1111.1101, and 1.1111.1111.1110.

8. The apparatus of claim 1, the apparatus further comprising an encode module configured to encode the data with a Scheme 2 encoding and a decode module configured to decode Scheme 2 encoded data.

9. A method for deploying computer infrastructure, comprising integrating computer-readable code into a computing system, wherein the code in combination with the computing system is capable of performing the following:
determining if data is to be encrypted when written to a magnetic tape in response to a host command and if the data is already encrypted;
encrypting the data if the data is to be encrypted and if the data is not already encrypted;
writing a reserved codeword followed by the data to the magnetic tape wherein the reserved codeword is configured as an encryption reserved codeword if the data is encrypted else the reserved codeword is configured as a clear data reserved codeword, wherein encrypted and unencrypted data segments are intermixed on the magnetic tape.

10. The method of claim 9, the method further comprising:
reading the magnetic tape as a plurality of words;
identifying the reserved codeword from plurality of words;
replacing the reserved codeword with zeros if the reserved codeword is the clear reserved codeword; and
transferring the data from the magnetic tape.

11. The method of claim 9, the method further comprising compressing the data.

12. The method of claim 11, the method further comprising:
reading the magnetic tape as a plurality of words;
identifying the reserved codeword from plurality of words;
decoding the compressed data;
decrypting the decoded data if the specified reserved codeword is the encryption reserved codeword; and
the read module further configured to transfer the data from the magnetic tape.

13. The method of claim 12, further comprising not decrypting the decoded data if the reserved codeword is the encryption reserved codeword and the magnetic tape being read in a raw data mode in response to a host command.

14. The method of claim 9, wherein the plurality of reserved codewords are Streaming Lossless Data Compression format reserved values.

15. A system for creating a self describing heterogeneous format, the system comprising:
a magnetic tape configured to store magnetically encoded data;
a head configured to write data to and read data from the magnetic tape;
a controller configured to write data to and read data from the magnetic tape through the head and comprising
a detection module comprising semiconductor circuits and configured to determine if data is to be encrypted when written to the magnetic tape in response to a host command and if the data is already encrypted;
an encryption module comprising semiconductor circuits and configured to encrypt the data if the data is to be encrypted and if the data is not already encrypted;
a write module comprising semiconductor circuits and configured to write a reserved codeword followed by the data to the magnetic tape wherein the reserved codeword is configured as an encryption reserved codeword if the data is encrypted else the reserved codeword is configured as a clear data reserved codeword, wherein encrypted and unencrypted data segments are intermixed on the magnetic tape;
a read module comprising semiconductor circuits and configured to read the magnetic tape as a plurality of words;
an identification module comprising semiconductor circuits and configured to identify the reserved codeword from plurality of words and replace the reserved codeword with zeros if the reserved codeword is the clear reserved codeword; and
the read module further configured to transfer the data from the magnetic tape.

16. The system of claim 15, the controller further comprising a compression module comprising semiconductor circuits and configured to compress the data.

17. The system of claim 16, wherein the controller comprises a decompression module comprising semiconductor circuits and configured to decode the compressed data and a decryption module comprising semiconductor circuits and configured decrypt the decoded data if the specified reserved codeword is the encryption reserved codeword.

18. The system of claim 17, wherein the decryption module does not decrypt the decoded data if the reserved codeword is the encryption reserved codeword and the read module is reading the magnetic tape in a raw data mode in response to a host command.

19. The system of claim 15, wherein the plurality of reserved codewords are Streaming Lossless Data Compression format reserved values.

20. The system of claim 15, the controller further comprising an encode module comprising semiconductor circuits and configured to encode the data with a Scheme 2 encoding and a decode module configured to decode Scheme 2 encoded data.
